(19) United States
(12) Patent Application Publication
(10) Pub. No.: US 2017/0270478 A1
(43) Pub. Date: Sep. 21, 2017

(54) MESSAGE DELIVERY SYSTEM AND METHOD

(71) Applicant: KEEPTREE, LTD., Tokyo (JP)

(72) Inventors: Hiroshi NAKATA, Tokyo (JP); Masayoshi KIMURA, Tokyo (JP)

(73) Assignee: KEEPTREE, LTD., Tokyo (JP)

(21) Appl. No.: 15/505,393

(22) PCT Filed: Aug. 21, 2015
(86) PCT No.: PCT/JP2015/073629

§ 371 Date: Feb. 21, 2017

(30) Foreign Application Priority Data
Aug. 22, 2014 (JP) 2014-169545

(51) Int. Cl. G06Q 10/08; H04L 12/58

(52) U.S. Cl. CPC G06Q 10/0833; H04L 51/046; H04L 51/22; H04L 51/36

(57) ABSTRACT

In a message delivery system, after completion of receiving a package, or after a deliverer has completed verification of the identity of a recipient of a package, a message associated with the package can be delivered to the recipient. For example, a message delivery system includes: a storage unit (130) that stores a message, a receiver of the message, information on a package associated with the message, and a delivery date and time at which the message is to be delivered; a receiving unit (1211) that receives identity verified data which indicates that a deliverer has verified the identity of the recipient upon delivery of the package; and a delivery unit (1212) that delivers the message associated with the package to the receiver after receiving the identity-verified data, or if no such identity verified data has been received even after the delivery date and time have passed.

### CROSS-REFERENCE TO RELATED APPLICATIONS

The present application is based on Japanese Patent Application No. 2014-169545, filed on Aug. 22, 2014, the disclosure of which is incorporated herein by reference.

### TECHNICAL FIELD

The present disclosure relates to a message delivery system and a message delivery method.

### BACKGROUND ART

Heretofore many technologies related to internet applications for enabling users to transmit messages and multimedia content have been known. For example, Patent Document 1 discloses a server apparatus which stores messages and content received from terminals in a data storage unit and delivers e-mail messages including URLs for viewing the stored messages and content to the respective destinations.

### CITATION LIST

### Patent Document

Patent Document 1: JP2004-355466 A

### SUMMARY

In the conventional methods, such as a delivery method using a server apparatus as disclosed in Patent Document 1, if, for example, one wishes to send a message together with a gift item, such message should be transmitted so that the message reaches the message receiver in a timely manner when the gift item is delivered to the receiver. In such a case, if the delivery is behind or ahead of schedule, the message will end up being delivered at a different time than the intended time of delivery of the message.

An object of the present disclosure is to provide a message delivery system, a message delivery method, and a program therefor, capable of delivering a message to the receiver of the message at a time at which a package is delivered. Another object of the present disclosure is to deliver a message when the identity of the recipient of a package is verified.

A message delivery system according to a particular embodiment in the present disclosure includes: a storage unit that stores a message, a receiver of the message, information on a package associated with the message, and a delivery date and time at which the message is to be delivered; a receiving unit that receives delivery completion data which indicates that the delivery of the package has been completed; and a delivery unit that, after receiving the delivery completion data, or if the receiving unit has not received the delivery completion data even after the delivery date and time have passed, delivers the message associated with the package to the receiver, wherein, after the receiver has viewed the delivered message, the delivery unit causes transition to a screen for setting redelivery of the package if the receiving unit has not received the delivery completion data.

The term “system” used in the present disclosure includes systems for providing particular functions to users, which are comprised of information processing devices, etc. Such systems are configured as, for example, but not limited to, a server apparatus, a cloud computing configuration, an ASP (Application Service Provider), or a client-server model.

In the present disclosure, a program can be installed or loaded onto a computer through a variety of storage media, including optical disks, such as CD-ROMs, magnetic disks, and semiconductor memory, or by being downloaded via a communication network, etc.

The term “unit,” as used in the present disclosure, does not simply mean a physical configuration, but rather includes cases in which a function included in such configuration is implemented by software. In addition, a function included in a single configuration may be implemented by two or more physical configurations and functions of two or more configurations may be implemented by a single physical configuration.

According to a particular embodiment in the present disclosure, a message can be delivered to the receiver of the message at a time at which a package is delivered. According to another particular embodiment in the present disclosure, a message can be delivered when the identity of the recipient of a package is verified.

### BRIEF DESCRIPTION OF DRAWINGS

The above objects and other objects of the present disclosure, as well as the features and advantages of the present disclosure, will become more apparent in the detailed description set forth below with reference to the accompanying drawings.

FIG. 1 is a diagram schematically illustrating an outline of message delivery processing implemented by a message delivery system according to a particular embodiment.

FIG. 2 is a system configuration diagram including a message delivery system according to a particular embodiment.

FIG. 3 is a sequence diagram showing the outline of processing performed by a message delivery system according to a first embodiment.

FIG. 4 is a flowchart showing the message delivery processing according to the first embodiment.

FIG. 5 is a flowchart showing message delivery processing according to a second embodiment.

FIG. 6 is an example of a flowchart showing the delivery of a package and the message delivery processing according to the first or second embodiment.

FIG. 7 is an example of a flowchart showing message delivery processing according to a third embodiment.

### DESCRIPTION OF EMBODIMENTS

Hereinafter, embodiments of the present invention will be described in detail. The below embodiments are merely examples for explaining the present invention and the present invention is not intended to be limited to those embodiments alone. Further, the present invention may be modified in various ways without departing from the gist thereof. A person skilled in the art could adopt embodiments in which each element described below has been replaced with its equivalents, and such embodiments will also be included in the scope of the present invention. Moreover, unless otherwise specified, the positional relationships, such as up-and-down and left-to-right relationships, indicated below as required, are based on the illustrations in the drawings. In addition, various dimensional ratios shown in the drawings are not limited to such illustrated ratios. In the below descriptions, for ease of understanding, embodiments in which the present invention is implemented by utilizing information processing devices will be described as examples; however, as already stated above, the present invention is not limited thereto.

### First Embodiment

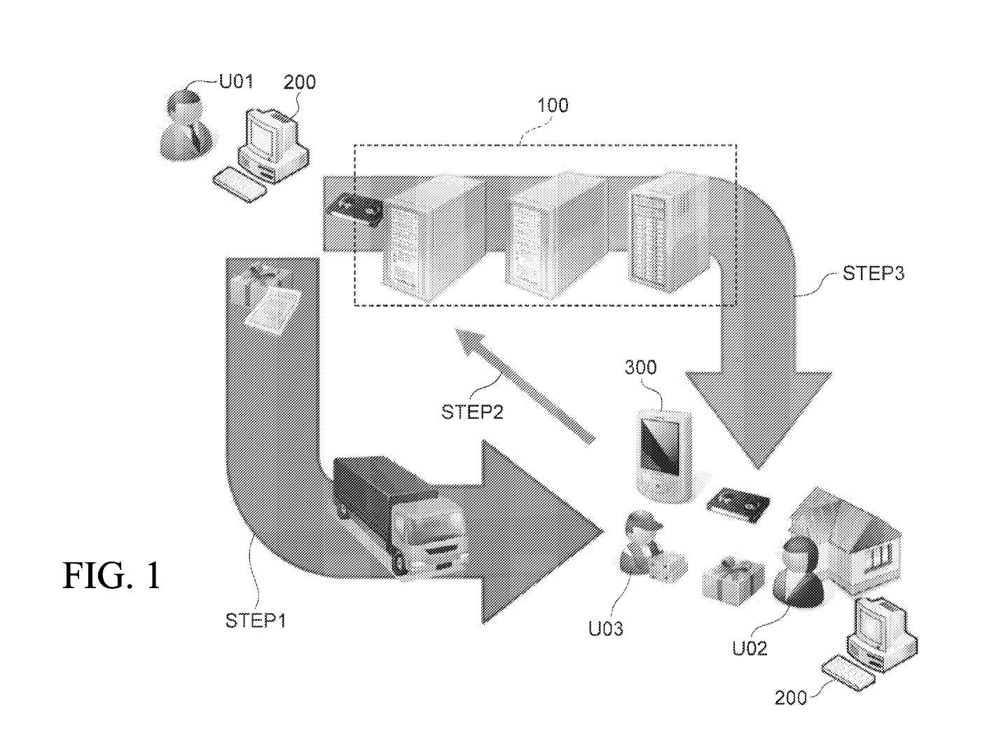

Firstly, an outline of the message delivery processing using a message delivery system 100 according to the present embodiment will be described with reference to FIG. 1. FIG. 1 is a diagram schematically illustrating an example of the message delivery processing using the message delivery system 100. In the present embodiment, each user will sign up as a member when the user wishes to use the message delivery system 100. Upon sign-up, the user is given a member ID and the member's own page is created for each member ID. When a user U01, who is a member of this system, sends a certain package, such as a gift, to a user U02, the user U01 can, by using this system, deliver a digital message to the user 02, i.e., the destination of the message, concurrently with the delivery date and time of the package. In the below description, a user who sends a message is called a sender user, and a user who is the destination of the message sent from the sender user is called a receiver user. It should be noted that the receiver user is desirably a member of this system, but may not be a member. In addition, even a person who is not a member of this system may be allowed to perform the message delivery processing using this system.

The sender user U01 asks a package delivery company U03 to deliver a package that the sender user U01 wishes to send to the receiver user U02, and the sender user U01 also enters, into the message delivery system 100, a digital message that the sender user U01 wishes to send to the receiver user U02 together with the package. When asking the package delivery company U03 to deliver the package, such a request may be made to the package delivery company U03 or its agent, or by connecting or linking this system with the system of the package delivery company so that the delivery of the package may be requested through this system. It should be noted that the “package delivery company” referred to in the present disclosure includes entities that deliver packages to general consumers, and such “package delivery company” is not limited to private package delivery companies but may also include postal service companies, etc.

The outline of the processing performed after the sender user U01 has asked for the package to be delivered and entered the digital message to be sent to the receiver user U02 together with the package into the message delivery system 100 is, for example, as shown in FIG. 1. Specifically, first, the package is delivered by the package delivery company U03 to the receiver user U02 (STEP 1). When the delivery of the package has been completed, the person who delivered the package (deliverer) operates a handheld terminal 300 and inputs the completion of the delivery. At that time, a delivery completion notice (hereinafter also referred to as “delivery completion data”) is transmitted from the handheld terminal 300 of the package delivery company U03 to a server apparatus (which will be described later) of the message delivery system 100, directly or via the system of the package delivery company (STEP 2). Upon receiving this delivery completion notice, the server apparatus 100 delivers the entered digital message to the receiver user U02 (STEP 3).

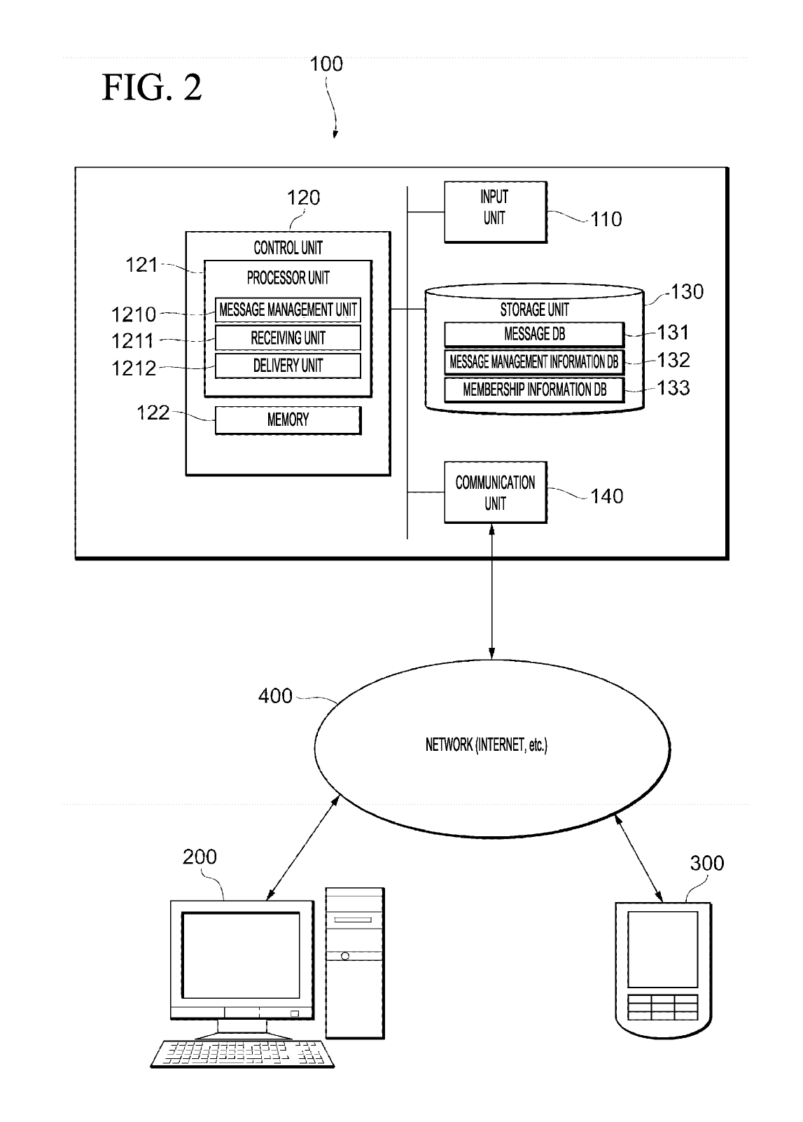

FIG. 2 shows an example of a system configuration diagram including the above-described message delivery system 100. As shown in FIG. 2, the message delivery system 100 is made of, for example, a server apparatus, and may be connected to a user terminal 200 and a handheld terminal 300 via a network 400. Hereinafter, the message delivery system 100 will sometimes be referred to as a server apparatus 100. It should be noted that the handheld terminal 300 may be configured to be connected to a host computer (not shown in the drawing), etc. of the package delivery company U03 to enable communication therebetween and that the host computer may be configured to be connected to the server apparatus 100 to enable communication therebetween.

The server apparatus 100 is a server computer which is connected to the network 400, such as the internet or a leased line. The client terminal 200 and the handheld terminal 300, which are terminal devices having a wired or wireless connection to the network 400 similarly to the server apparatus 100, are set so as to be able to communicate with each other, thereby constituting the message delivery system 100. In the present embodiment, the message delivery system 100 is described as a system which is made of a server apparatus 100, but the message delivery system 100 is not limited thereto. For example, the message delivery system 100 may be configured as a system of a cloud computing model. In such case, users utilize the computer processing implemented by the message delivery system 100 as a service provided via a network. The message delivery system 100 may also be configured as a system including an ASP server.

The user terminal 200 is an information processing device having the function of communicating with the server apparatus 100 via the network 400. Specific examples thereof include, but are not limited to, cellular phones, smartphones, PCs, PDAs and tablets. Although not shown in FIG. 2, the user terminal 200 may have, for example, a control unit including a CPU and memory, a communication unit for connection with the network 400, a display unit for displaying an input unit, such as a touch panel, that receives a user's operation, and a storage unit.

The handheld terminal 300 refers to a terminal device that the deliverer of the package delivery company U03 is carrying during the delivery of packages. The deliverer uses the handheld terminal 300 to retrieve delivery-related information from the host computer of the package delivery company U03 and to input information regarding the status of the delivery, such as completion of delivery, completion of identity verification, and so on. In response to an input from the deliverer, the handheld terminal 300 transmits the delivery status data, such as completion of delivery, to the server apparatus 100, directly through the network 400 or indirectly via, for example, a host computer of the package delivery company U03. The delivery status data includes the slip number of the package and the status of the delivery. For example, delivery completion data may include the slip number of the package that has been delivered, the date and time of the delivery, the recipient of the package and the delivery status which indicates that the delivery has been completed.

It should be noted that, in the present embodiment, the host computer of the package delivery company U03 may be an apparatus provided externally to the message delivery system 100, but such host computer is configured to be connected or linked to the message delivery system 100 so as to send and receive necessary information to and from the message delivery system (server apparatus) 100.

Next, each constituent element of the server apparatus 100 will be described. As illustrated in FIG. 2, the server apparatus 100 has an input unit 110, a control unit 120, a storage unit 130 and a communication unit 140.

The input unit 110 is configured to receive an operation by an administrator of the server apparatus 100, and such input part 110 can be implemented by, for example, a keyboard, a mouse, or a touch panel.

The control unit 120 has a processor unit 121, such as a CPU or MPU, a memory 122 such as RAM, and an image processing unit 122 (not shown in the drawing). In response to various inputs, the processor unit 121 executes programs stored in the storage unit 130, thereby operating each functional unit. Such programs may be stored on a storage medium, such as a CD-ROM, or distributed through the network 400 and installed on a computer. The memory 122 temporarily stores various data necessary for operation, etc., during the execution of certain processing on a server program and other programs.

The storage unit 130 is made of a storage device, such as a hard disk, and stores thereon various programs necessary for the execution of processing in the control unit 120, as well as necessary data, etc., for the execution of such various programs. In the present embodiment, the storage unit 130 includes a message database (message DB) 131, a message management information database (message management information DB) 132, and a membership information database (membership information DB) 133.

The message DB 131 stores digital messages entered by the sender users of the messages. For example, a digital message that the user wishes to send together with a package is stored in association with a message ID. The message ID may be a given ID as long as it can identify the message in this system, and this example describes the case in which a slip number, which is given when the sender user U01 requests the package delivery company U03 to deliver a package, is used as a message ID.

A digital message may include a given form of digital content, such as a video letter made by the sender user for the receiver user, a slide show of still images, audio data, etc. The sender user can upload the digital message on the server apparatus 100 by using the client terminal 200.

The message management information DB 132 stores information for managing the delivery of digital messages (message management information). More specifically, it stores the message ID, information about the destination of the delivery of the message, the delivery status of the package, and the delivery date and time of the message, in association with each other. In this example, the slip number of the package is used as the message ID, as has already been described above. The information about the destination of the delivery of the message includes address information for the destination of the digital message. The address information includes information concerning, for example, the member ID, e-mail address and cellular phone number of the receiver user U02 (i.e., the intended receiver of the message). Further, the information about the delivery destination of the message may also include information about the name and the like of the receiver user. The delivery status of the package may include, for example, information indicating that: the package associated with the particular slip number has not been delivered (Delivery Incomplete); the package associated with the particular slip number has been delivered (Delivery Completed); the identity of the recipient of the package has been verified at the time of delivery of the package (Identity Verified); and the recipient of the package has moved (Change of Address). The delivery date and time of the message indicates the date and time at which the message is expected to be sent, in the case where the package has not been delivered for some reason. This delivery date and time of the message may be set arbitrarily by the sender user U01, or may be predetermined to be a date and time at which a particular time has passed from the desired delivery date and time of the package. It should be noted that, preferably, the delivery date and time of the message is controlled by a message management unit 1210, which will be described below, so that it is not possible to specify a date and time prior to the desired delivery date and time of the package. Furthermore, for example, the sender user's member ID and the number of times that the message was played may also be recorded as the message management information.

It should be noted that the addressee of the package which is to be delivered together with the message may not always be the same as the receiver user. For example, when a gift is addressed to a child, the receiver user of a message associated with the gift may be his/her parent. Moreover, one message may be sent to more than one receiver user. For example, when one gift is addressed and delivered to a family, the receiver users of the associated message may be all the members of such family.

For the information of the receiver user, if the receiver user has already signed up with the message delivery system, the member ID can be used. If the receiver user is not a member of the message delivery system, the information of the receiver user may include a flag indicating that the receiver user is not a member, together with the mail address and name of the user. The message recorded on the message DB 131 is stored in association with the message management information recorded on the message management information DB 132.

The membership information DB 133 stores information on member users. For example, the member ID, mail address, name, postal address, etc., may be recorded.

The communication unit 140 is configured to connect the server apparatus 100 to the network 400. For example, the communication unit 140 may be implemented by a LAN card, an analog modem, an ISDN modem and the like, along with an interface for connecting them with the processing unit via a transmission path, such as a system bus.

As also illustrated in FIG. 2, the processor unit 121 has, as the functional units thereof, a message management unit 1210, a receiving unit 1211, and a delivery unit 1212.

The message management unit 1210 receives a message and the relevant message management information for the message from the sender user, and enters the received message and message management information into the message DB 131 and the message management information DB 132, respectively. Further, the message management unit 1210 can execute processing for playing the message upon receiving a request to play the message from the receiver user. In the present embodiment, control is performed such that a message can be entered or played only when a member of the system is logging into the member page. Accordingly, if the receiver user is not a member of the system, such receiver user first needs to sign up with the system as a member. When the non-member receiver user has signed up with the system, the message management unit 1210 removes the non-member flag put on the message management information DB 132 and enters the member ID of the receiver user. When the receiver user, who has become a member, logs into the member page and submits a request to play the message, the message management unit 1210 preferably checks whether the member ID of the requesting user matches the member ID of the receiver user recorded on the message management information DB 132, and permits the playing of the message if they match. As a result, a message can be prevented from being played by a user who is not the receiver user.

The receiving unit 1211 receives, through the communication unit 140, the delivery status data which indicates, for example, the completion of the delivery of the package to the receiver of the message, directly from the handheld terminal 300 or via a host computer, etc., of the package delivery company U03. When the delivery completion data is received directly from the handheld terminal 300, the receiving unit 1211 obtains, from the received delivery status data, the slip number and the delivery status indicating that the delivery has been completed. When the delivery completion data is sent from the handheld terminal 300 to a host computer of the package delivery company U03, the host computer transmits, in response to the receipt of the delivery status data, the slip number and the delivery status which have been extracted from the received delivery status data to the delivery server 100.

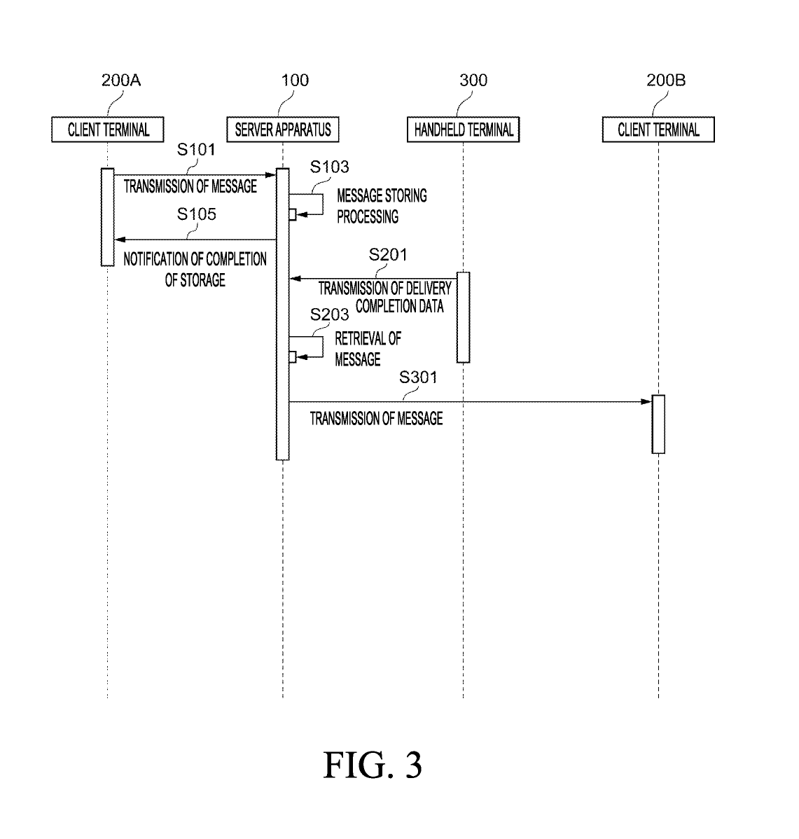

FIG. 3 is a sequence diagram showing an example of the outline of processing performed by the message delivery system 100 of the present embodiment. In FIG. 3, description will be made assuming that the sender user U01 of a message operates a client terminal 200A, while the receiver user U02 operates a client terminal 200B. In addition, in this example, the sender user U01 is a member of a message delivery service using the message delivery system 100. It should be noted that this example describes the case in which the receiver user U02 is the recipient of the relevant package, but the receiver user U02 may not always be the recipient of the package.

When the sender user U01 has asked for a package to be delivered, the sender user U01 operates the client terminal 200A so as to enter a message to be delivered together with the package. For example, the sender user U01 logs into the user's own member page and, on that page, uploads the message the sender user U01 wishes to transmit to the receiver user U02 (S101). At that time, the sender user U01 enters a digital message together with the information (member ID, mail address, etc.) about the receiver user U02 who is the destination of the message, the delivery date and time of the message, and the slip number which was given when the sender user U01 asked for the package to be delivered. The sender user U01 may also enter his/her member ID, but such member ID of the sender user U01 may be configured so as to be obtained automatically.

When the message management unit 1210 of the server apparatus 100 receives a request to enter a message, it stores the message on the message DB 131 and also stores information about the receiver user U02, etc., on the message management information DB 132 (S103).

Next, when the package has been delivered to the receiver user U02 by the package delivery company U03, the deliverer inputs the completion of the delivery on its handheld terminal 300, as the delivery status. In response to the input, the handheld terminal 300 transmits the delivery completion data to the receiving unit 1211 of the server apparatus 100, directly or via, for example, a host computer of the package delivery company U03 (S201). The delivery completion data includes the slip number on the delivered package and the information indicating that the delivery has been completed.

When the receiving unit 1211 receives the delivery completion data, the delivery unit 1212 retrieves a message and message management information associated with the received slip number (S203). The delivery unit 1212 uses the retrieved message management information so as to transmit e-mail to the specified receiver user U02 to prompt the user U02 to see the message (S301). Here, if a certain time lag from the completion of the delivery of the package to the delivery of the message is recorded on the message management DB 132, the message is delivered after the recorded time has passed. With this configuration, for example, in the case where a food item is sent as a gift, the sender can deliver a message at an appropriate time when the receiver has already eaten the food item.

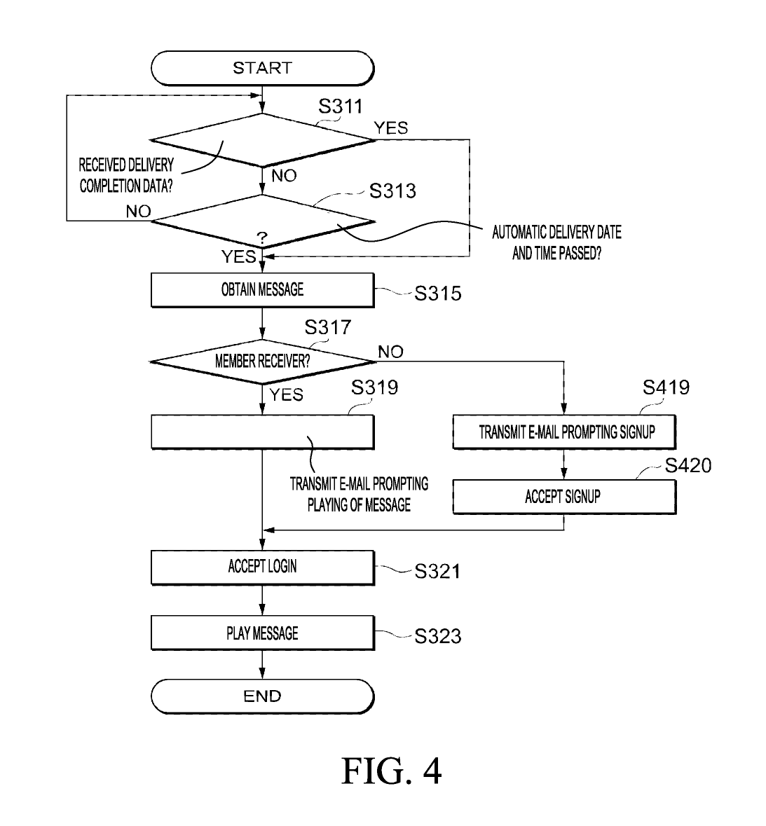

The procedure in which the server apparatus 100 transmits a message (S201 to S301) will now be described in detail by referring to FIG. 4. FIG. 4 is a flowchart showing an example of the procedure for the message transmission processing.

When the receiving unit 1211 of the server apparatus 100 receives delivery completion data (S311: YES), the receiving unit 1211 provides a notification to the delivery unit 1212, stating that a message should be transmitted. In response to the notification, the delivery unit 1212 extracts from the message management information DB 132 the message management information associated with the slip number received by the receiving unit 1211. The delivery unit 1212 further obtains a message associated with the extracted message management information from the message DB 131 (S315). Next, the delivery unit 1212 refers to the information of the receiver user U02 included in the obtained message management information, so as to determine whether or not the receiver of the message is a member (S317). If the receiver user U02 is a member, an e-mail message that prompts the receiver user U02 to log into the member page and play the message is sent based on the relevant membership information (S319). Such e-mail message preferably includes the URL to the member page. With this URL to the member page, the receiver user U02 logs in (S321), thereby being allowed to play the message (S323).

On the other hand, if the receiver user U02 is not a member, an e-mail message is transmitted that prompts the receiver user U02 to sign up with the system (S419). Such e-mail message preferably includes the URL to the sign-up page. When the receiver user U02, who is not a member of the system, accesses the sign-up page through the URL to this page and then signs up, the server apparatus 100 accepts the sign-up request (S421). Upon completion of the sign-up step, the receiver user U02 can play the message through the member page (S323).

If the receiving unit 1211 has not received the delivery completion data in step S311 (S311: NO) and if the recorded delivery date and time of the message have passed (S313: YES), the delivery unit 1212 executes the message delivery processing without waiting for the receiving unit 1211 to receive the delivery completion data. As a result, it is possible to prevent a message that should be delivered on a particular date, for example, a birthday, from being delivered on another day due to a delay in the arrival of the gift. As stated above, according to the message delivery system 100 of the present embodiment, a message can be delivered at a time when a gift is delivered to the receiver of the message.

### Second Embodiment

Next, a second embodiment of the present invention will be described. In this embodiment, the message management unit 1210 permits the playing of the message even if the receiver user U02 is not a member. In this case, the message management unit 1210 can limit the number of times that the receiver user U02 can play the message if the receiver user U02 is not a member. More specifically, when the message management unit 1210 receives an entry of a message, it determines whether or not the receiver user is a member. If the receiver user is not a member, a non-member flag is displayed and the specific number of plays is recorded on the message management information DB 132, so that the message is controlled so as not to be played beyond the specific number of times. When the receiver user U02 is a member, the processing is performed in the same way as in the first embodiment.

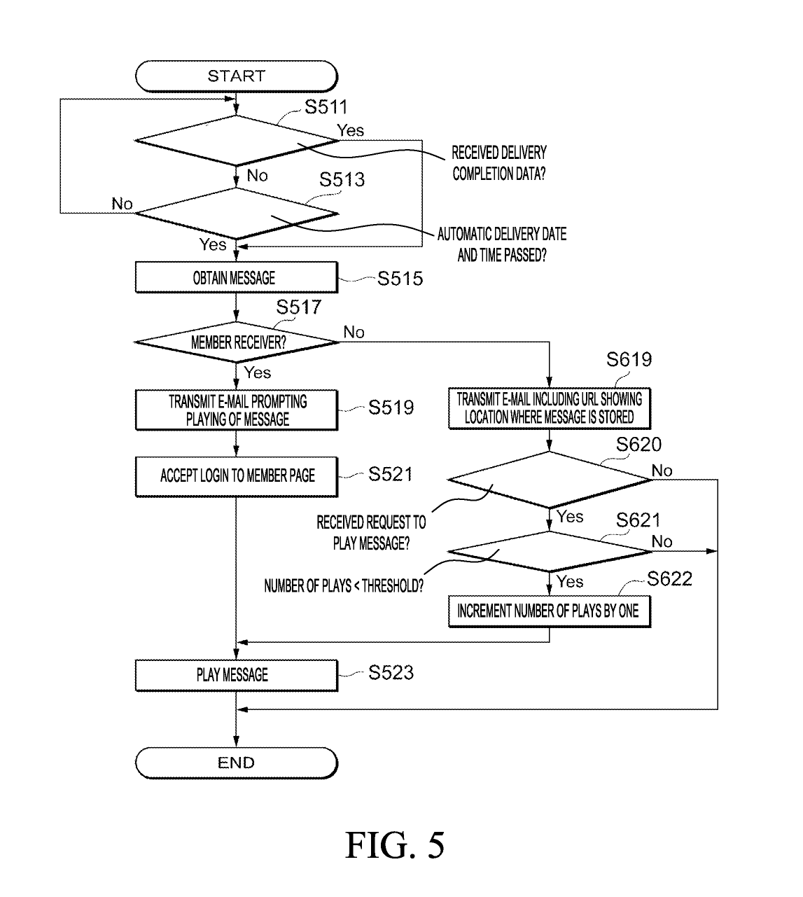

The procedure of the message delivery processing according to this embodiment will now be described in detail by referring to FIG. 5. It should be noted that, since the processes in S511 to S523 in FIG. 5 are the same as those in the message delivery processing of the first embodiment shown in FIG. 4, the description of these processes will be omitted here.

If the receiver user U02 of the message is not a member in S517, the delivery unit 1212 transmits an e-mail message describing the URL to the location where the message is stored (S619). When the receiver user U02 accesses the described URL, a request to play the message is transmitted to the message management unit 1210 (S620: YES). The message management unit 1210 refers to the message management information DB 312, to check the number of times that the message can be played. When the number of times that the message has been played is less than the predetermined threshold (S622: YES), the message management unit 1210 updates the number of plays by incrementing it by one, and plays the message (S523).

As stated above, according to the message delivery system 100 of this embodiment, if the receiver user U02 of a message is not a member, the receiver user U02 is allowed to play the message without being prompted for sign-up. In addition, by setting an upper limit to the number of times that a non-member user can play the message, it is possible to motivate such non-member user to sign up.

Other configurations, functions and effects are the same as those in the first embodiment.

### EXAMPLE

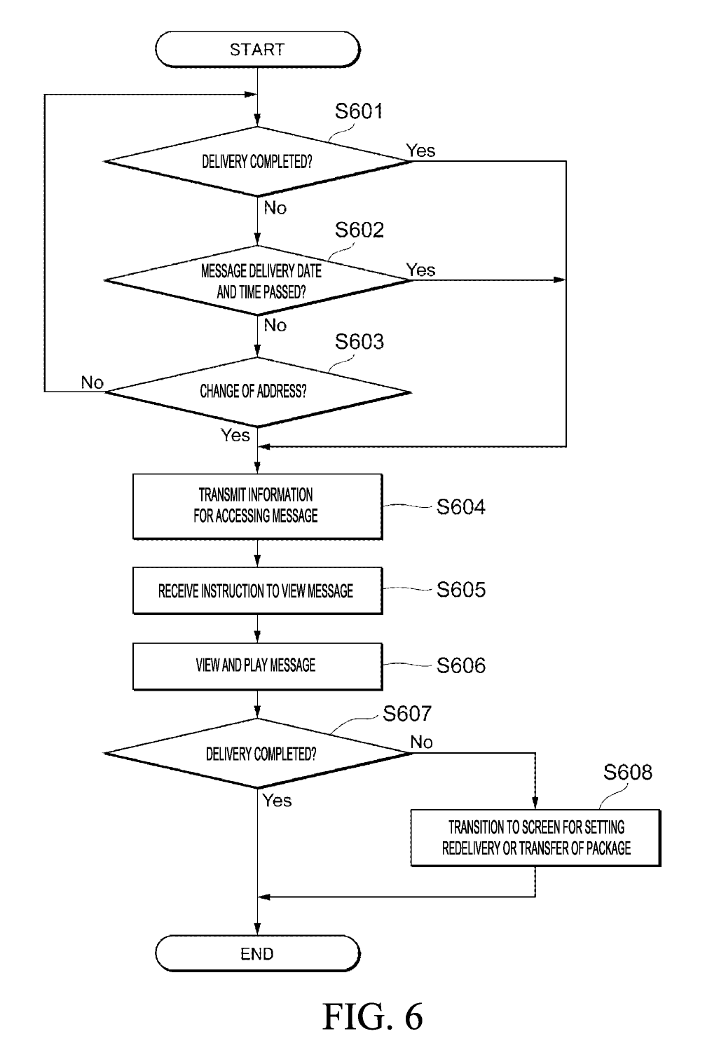

Next, an example of the procedure of the delivery of a package and message delivery processing will be described. FIG. 6 is a flowchart showing the delivery of a package and the message delivery processing according to the first or second embodiment.

In the above description of the first embodiment or the second embodiment, the processing performed when the delivery of a package has been completed before the delivery date and time of the message, and the processing performed when the delivery of a package has not been completed by the delivery date and time of the message, have been described.

Specifically, in the former case, when the delivery of the package has been completed before the delivery date and time of the message (S601: YES), the delivery server (the server apparatus) 100 transmits information for accessing the message to the receiver user, regardless of the delivery date and time of the message, by being triggered by the delivery status that has been changed from Delivery Incomplete to Delivery Completed (S604). As a result, the receiver user will be able to view the message on condition that the package has been delivered (S606).

In the latter case, when the delivery of the package has not been completed by the delivery date and time of the message (S602: YES), the delivery server 100 transmits information for accessing the message to the receiver user even though the delivery status is still Delivery Incomplete, by being triggered by the fact that the delivery date and time of the message have passed (S604). As a result, the receiver user will be able to view the message no later than the date and time specified by the sender user even if the package has not been delivered (S606). In this case, when the receiver user views the message, it is preferable to cause transition to a screen on which the date and time of the redelivery of the package can be set after the playing of the message (S608). With this configuration, even if the package is not delivered on schedule or if the recipient is absent, the relevant message can still be sent to the receiver user at an appropriate time at which the message should be delivered and, moreover, the receiver user can quickly and easily arrange for the redelivery of the package.

Furthermore, in the case where the package cannot be delivered because the addressee of the package has moved to another place (S603: YES), the delivery server 100 may transmit information for accessing the message to the receiver user even if the delivery of the package has not been completed and if it is before the delivery date and time of the message (S604), so that the receiver user can view the message. In that case, when the receiver user views the message, it is preferable to cause transition to a screen on which the receiver user can set the address which the package should be transferred to and the date and time of such redelivery, after the playing of the message (S608). With this configuration, even if the recipient has moved to another place, the relevant message can still be sent to the receiver user and, moreover, the receiver user can quickly and easily make the necessary arrangements for redelivering the package to a new address and can also ensure the receipt of the package even if the recipient has moved to another place.

The processing performed when the recipient has moved is as follows: First, when the deliverer has attempted to deliver the package but found that the recipient has moved, the deliverer enters an input to the handheld terminal 300 which indicates that the recipient has moved (S603: YES). In response to the input, the handheld terminal 300 transmits to the server apparatus 100 the change-of-address data which indicates that the recipient has moved, directly or via, for example, a host computer of the package delivery company U03. The change-of-address data includes the slip number on the package and the information indicating that the recipient has moved. Upon receiving the change-of-address data, the server apparatus 100 changes the delivery status in the message management information corresponding to the received slip number from Delivery Incomplete to Change of Address. By being triggered by the delivery status that has been changed to Change of Address, the server apparatus 100 transmits information for accessing the message to the receiver user (S604).

After that, the receiver user provides an instruction to view the message by, for example, clicking a link to a website where the message can be played. Upon receiving the instruction from the client terminal 200 to view the message (S605), the delivery server 100 plays the message (S606).

The processing performed after the delivery of the message is as follows: When the playing of the message by the receiver user has ended, the delivery server 100 checks the delivery status associated with the message (S607). If the delivery status is Delivery Completed (S607: YES), the delivery server 100 directly ends the processing for playing the message. If the delivery status is Delivery Incomplete (S607: NO), the delivery server 100 causes transition to a screen on which the date and time of the redelivery of the package can be set (S608). In addition, if the delivery status is Change of Address (S607: NO), the delivery server 100 causes transition to a screen on which a new address which the package should be transferred to and the date and time of such redelivery can be set (S608). In this way, by automatically causing transition to a screen for making an appropriate arrangement according to the delivery status after the playing of the message, it is possible to further ensure that the package is delivered to the recipient.

### Third Embodiment

A third embodiment of the present invention will be described next. This embodiment is aimed at further ensuring that a digital message is correctly delivered to the receiver by verifying the identity of the receiver at the time of delivery of the relevant package. Since the system configuration of this embodiment is the same as that of the first or second embodiment, the description thereof will be omitted here.

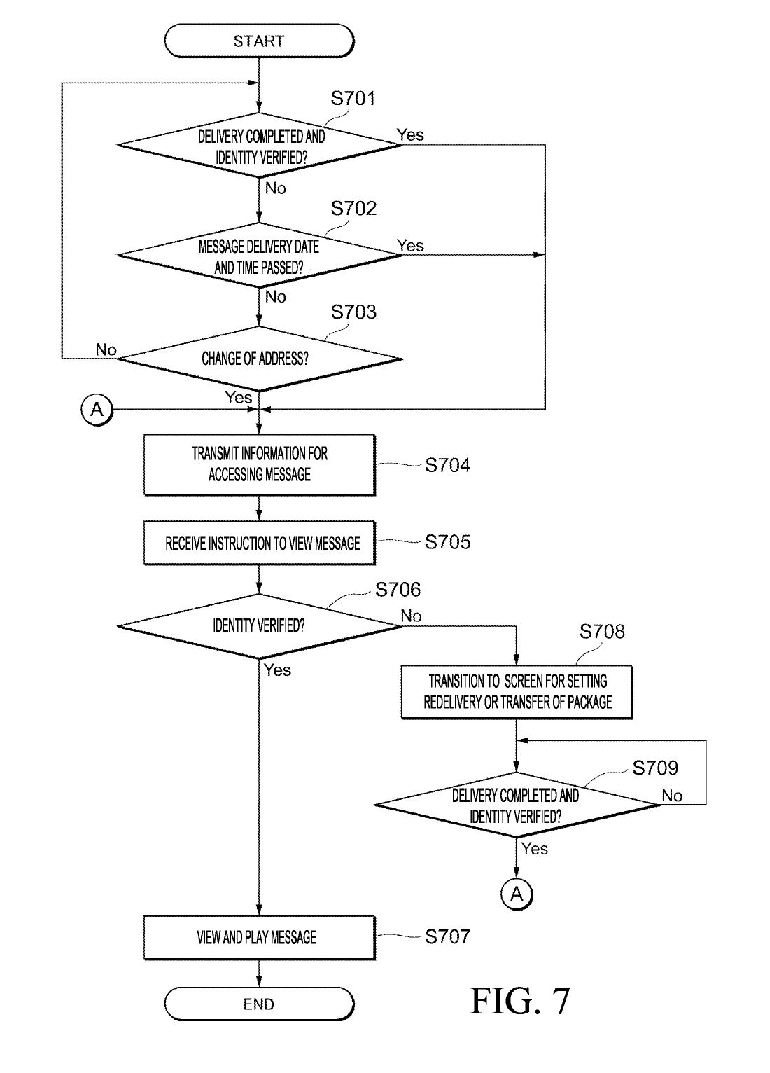

An example of the procedure according to the third embodiment will be described below by referring to FIG. 7. FIG. 7 is an example of a flowchart of the message delivery processing of the present embodiment.

(When the Delivery of the Package and Identity Verification have been Completed Before the Delivery Date and Time of the Message)

In the present embodiment, the identity of the recipient is confirmed when the deliverer of the package delivery company U03 has delivered the package (S701). If the identity is verified, the deliverer enters an input to the handheld terminal 300 which indicates that the identity has been verified (S701: YES). In other words, when the package has been delivered, the completion of the delivery is input to the handheld terminal 300 in the first or second embodiment; whereas, in the present embodiment, the completion of identity verification is input instead of, or in addition to, such input of the completion of the delivery.

Various methods can be used for identity verification. For example, the deliverer can verify the identity by asking the recipient to show his/her passport or driver's license, but applicable methods are not limited thereto.

Further, if the identity has been verified, it is preferable for the deliverer to show address information, such as an e-mail address and a cellular phone number, of the receiver user U02, which has been entered by the sender user U01, on the handheld terminal 300 so that the recipient can check whether or not the address information is correct. If the address information is correct, the deliverer inputs the completion of the identity verification. On the other hand, if the address information includes errors, the deliverer asks the recipient to correct the address information and, after that, inputs the completion of the identity verification.

In response to the input of the completion of the identity verification, the handheld terminal 300 transmits to the server apparatus 100 identity-verified data which indicates that the identity of the recipient has been verified, directly or via, for example, a host computer of the package delivery company U03. The identity-verified data includes the slip number of the package, information indicating that the identity of the recipient has been verified, and, if applicable, the corrected address information.

Upon receiving the identity-verified data, the server apparatus 100 changes the delivery status in the message management information associated with the received slip number from Delivery Incomplete to Identity Verified. In addition, if the identity-verified data includes address information, the server apparatus 100 rewrites the address information of the destination of the message, which is recorded in the message management information, to the corrected address information included in the identity-verified data. After that, by being triggered by the change of the delivery status to Identity Verified, the server apparatus 100 transmits information for accessing the message to the receiver user (S704). For example, an e-mail message or a short message which includes a link to a website where the message can be played is transmitted to the receiver user.

After that, the receiver user provides an instruction to view the message by, for example, clicking the link. Upon receiving the instruction from the client terminal 200 to view the message (S705), the delivery server 100 checks the delivery status associated with the message (S706). If the delivery status is Identity Verified (S706: YES), the delivery server 100 permits the viewing of the message and plays the message (S707). In this manner, after the identity has been verified at the time of delivery of the package, the delivery server 100 can deliver the message more accurately to the receiver.

(When the Package has not been Delivered Before the Delivery Date and Time of the Message)

When the delivery of the package has not been completed by the delivery date and time of the message for some reason (S701: NO), the delivery server 100, by being triggered by the fact that the delivery date and time of the message have passed (S702: YES), transmits information for accessing the message to the receiver user (S704) even though the delivery status is still Delivery Incomplete.

When the receiver user attempts to view the message, the delivery server 100 checks the delivery status associated with the message (S706). If the delivery status is Delivery Incomplete at that time (S706: NO), the delivery server 100 does not permit the viewing of the message and, instead of playing the message, it indicates that the message will only be able to be played upon completion of the identity verification, and causes transition to a screen on which the date and time of the redelivery of the package can be set (S708).

When the receiver user arranges the redelivery and then receives the package, the identity is confirmed by the deliverer (S709). If the identity of the recipient is verified (S709: YES), the delivery status is changed to Identity Verified, as described above. After that, the receiver user is able to view the message.

With this configuration, even if the package is not delivered on schedule or if the recipient is absent, the receiver user is informed of the existence of the message at a time when the message should be delivered, and the receiver user is further prompted to take the step of arranging the redelivery of the package, so that the receiver user will be able to view the message after the completion of the identity verification.

(When the Recipient of the Package has Moved)

If the recipient of the package has moved to another place so that the package cannot be delivered to such recipient (S703: YES), the delivery server 100 may transmit information for accessing the message to the receiver user even if the delivery of the package has not been completed and if it is before the delivery date and time of the message (S704).

In that case, when the receiver user attempts to view the message, the delivery server 100 checks the delivery status associated with the message (S706). If the delivery status is Change of Address (S706: NO), the delivery server 100 does not permit the viewing of the message and, instead of playing the message, indicates that the message will only be able to be played upon completion of the identity verification and causes transition to a screen on which a new address which the package should be transferred to and the date and time of such redelivery can be set (S708).

In the above case, similarly to the case where the delivery of the package has not been completed, the receiver user will be able to view the message when the receiver user has received the package and the identity has been verified by the deliverer (S709: YES).

As described above, in the present embodiment, a message can be delivered when the receiver user has received the package and the identity of the recipient of the package has been verified.

### EXAMPLE

In the third embodiment, whether or not the identity of the recipient needs to be verified upon delivery of the package may be configured so as to be able to be set by the sender user U01 who sends the package or message. Specifically, the sender user U01 sets whether or not the identity of the recipient needs to be verified at the time of, for example, asking for the delivery of the package or entering a digital message to be delivered together with the package. Such setting may be made by, for example, placing a check mark in a specified area in the request form or entry screen to indicate that identity verification is necessary.

Regarding the package for which identity verification is necessary, the need for identity verification is entered on, for example, a host computer of the package delivery company U03. In addition, the need for identity verification is also entered on the message management information DB 132 of the delivery server 100 as the delivery status (Identity Verification Required).

At the time of delivery of the package, the deliverer checks whether or not identity verification is necessary for the package by accessing, for example, a host computer of the package delivery company U03 from the handheld terminal 300. If identity verification is not necessary, the deliverer transmits the delivery completion data from the handheld terminal 300 at the time when the delivery of the package has been completed. On the other hand, if identity verification is necessary, the deliverer delivers the package only after verifying the identity of the recipient, and transmits the identity-verified data from the handheld terminal 300 at the time when both the delivery of the package and the identity verification have been completed.

After the completion of the delivery of the package, or, for example, if the delivery of the package has not been completed even after the delivery date and time of the message have passed, information for accessing the message is transmitted from the delivery server 100 to the recipient of the package. When the recipient attempts to view the message, the delivery server 100 checks the delivery status of the associated package and conducts appropriate processing according to such delivery status. Specifically, if the delivery status is Delivery Completed or Identity Verified, the delivery server 100 permits the viewing of the message and plays the message. If the delivery status is Delivery Incomplete and Identity Verification Not-Required, the delivery sever 100 plays the message and then causes transition to a screen for setting the redelivery of the package. On the other hand, if the delivery status is Delivery Incomplete and Identity Verification Required, the delivery server 100 causes transition to a screen for setting the redelivery of the package, without playing the message. If the delivery status is Change of Address, the delivery server 100 similarly causes transition to a screen for setting the transfer of the package after playing the message, if identity verification is unnecessary, or without playing the message, if identity verification is necessary.

As described above, in the above example, a message can be delivered to the receiver at an appropriate time when the relevant package has been delivered, and furthermore, a message can be delivered when the identity of the recipient of the relevant package has been verified.

Embodiments of the present invention have been described in the above; however, the present invention is not limited to the described embodiments and may be modified or altered in various ways based on the technical idea of the present invention.

For example, the above-described embodiments explain the configuration in which the delivery unit 1212 delivers an e-mail message by incorporating therein a URL for logging into the system or a URL for viewing the message; however, the delivery unit 1212 is not limited to such configuration. For example, the delivery unit 1212 may directly deliver the message by attaching it to an e-mail message.

The above-described embodiments are configured such that a user needs to sign up with a message delivery system when the user wishes to use the system; however, the present invention is not limited to such configuration. The message delivery system may be configured to be available without signing up.

The above-described embodiments explain the case where the sender user U01 gives something as a gift to the receiver user U02; however, needless to say, an item to be delivered is not limited to being a gift and any item may be delivered. In other words, the present disclosure can also be applied to cases in which, when the sender sends a given item to the receiver, the sender also sends a given piece of digital content together with such item.

Furthermore, the above-described embodiments explain the case where the delivery status is managed by using the message management information DB 132 in the server apparatus 100; however, the present invention is not limited to such configuration. For example, instead of managing the delivery status using the message management information DB 132, the server apparatus 100 may be configured to access a host computer of the package delivery company U03, when required, so as to check the delivery status of the package having the desired slip number.

Moreover, the above-described embodiments are configured such that, if the message is delivered before the delivery of the package, transition to a screen for setting the redelivery or transfer of the package is caused after the message is played; however, such transition to a screen for setting the redelivery or transfer of the package is not limited to being performed after the playing, and may also be performed before or during the playing.

In addition, the above-described embodiments explain examples in which the message is not allowed to be played until the identity verification has been completed, even if the delivery date and time of the message have passed; however, a configuration in which the message is allowed to be played when the delivery date and time of the message have passed, even if the identity has not yet been verified, is also possible.

In some parts of the present disclosure, description has been made by assuming that a “gift item” or a “gift” is sent from the sender to the receiver. Such “gift item” or “gift” referred to herein is not necessarily limited to items sent as a gift, but includes any package which is sent from the sender to the receiver (e.g., postal items, parcels, home delivery packages).

What is claimed is:

1. A message delivery system comprising:
a storage unit that stores a message, a receiver of the message, information on a package associated with the message, and a delivery date and time at which the message is to be delivered;
a receiving unit that receives delivery completion data which indicates that the delivery of the package has been completed; and
a delivery unit that, after receiving the delivery completion data, or if the receiving unit has not received the delivery completion data even after the delivery date and time have passed, delivers the message associated with the package to the receiver, wherein, after the receiver has viewed the delivered message, the delivery unit causes transition to a screen for setting redelivery of the package if the receiving unit has not received the delivery completion data.

2. A message delivery system comprising:
a storage unit that stores a message, a receiver of the message, information on a package associated with the message, and a delivery date and time at which the message is to be delivered;
a receiving unit that receives identity verified data which indicates that a deliverer has verified an identity of a recipient upon delivery of the package; and
a delivery unit that, after receiving the identity verified data, or if the receiving unit has not received the identity verified data even after the delivery date and time have passed, delivers the message associated with the package to the receiver.

3. The message delivery system according to claim 2, wherein, if the receiving unit has not received the identity verified data even after the delivery date and time have passed, the delivery unit causes transition to a screen for setting redelivery of the package before delivering the message.

4. A control method implemented by a computer, comprising:
storing a message, a receiver of the message, information on a package associated with the message, and a delivery date and time at which the message is to be delivered;
receiving delivery completion data which indicates that the delivery of the package has been completed; and
after receiving the delivery completion data, or if the delivery completion data has not been received even after the delivery date and time have passed, delivering the message associated with the package to the receiver, wherein, after the receiver has viewed the delivered message, transition to a screen for setting redelivery of the package is caused if the delivery completion data has not been received.

5. A computer-readable storing medium which stores thereon a program for causing a computer to execute:
storing a message, a receiver of the message, information on a package associated with the message, and a delivery date and time at which the message is to be delivered;
receiving delivery completion data which indicates that the delivery of the package has been completed; and
after receiving the delivery completion data, or if the delivery completion data has not been received even after the delivery date and time have passed, delivering the message associated with the package to the receiver, wherein, after the receiver has viewed the delivered message, transition to a screen for setting redelivery of the package is caused if the delivery completion data has not been received.
